(19) United States
(12) Patent Application Publication
(10) Pub. No.: US 2015/0371562 A1
(43) Pub. Date: Dec. 24, 2015

(54) Folding Card

(71) Applicant: David L. Feigenbaum, Winchester, MA (US)

(72) Inventor: David L. Feigenbaum, Winchester, MA (US)

(21) Appl. No.: 14/745,805

(22) Filed: Jun. 22, 2015

Related U.S. Application Data
(60) Provisional application No. 62/016,356, filed on Jun. 24, 2014.

(51) Int. Cl. G09F 1/06; A47G 1/06; A47G 1/14; G09F 1/12

(52) U.S. Cl. CPC G09F 1/06; G09F 1/12; A47G 1/0633; A47G 1/141; A47G 1/143

(57) ABSTRACT

Among other things, a card blank has a first panel connected along a first fold line to a second panel. The second panel is connected along a second fold line to a third panel. The blank is foldable to form a first configuration in which the first panel, the second panel, and the third panel lie flat against one another. Alternately, the blank is foldable to form a second configuration in which (a) two of the panels can be mated to cause the folding card to form a three-dimensional free-standing card, (b) a bottom of the card has exposed points of contact that lie on a plane to permit the card to rest stably on a surface that is parallel to the plane, and (c) one of the panels is oriented at an angle of between 55 degrees and 85 degrees to the plane.

This application is a utility conversion and claims the benefit of priority from U.S. provisional application No. 62/016,356, filed Jun. 24, 2014, the content of which is incorporated herein in its entirety.

### BACKGROUND

This description relates to a folding card.

A greeting card, for example, often has a front printed rectangular panel joined at a fold line along its left edge to a back panel. Art work, such as a photograph, can be attached to the front panel. A message can be printed or written on the inside of the back panel. The card can be closed flat to mail it in an envelope or opened up so that the two panels are at an angle to one another. Then the card can be put on a desk or table to display the photograph.

### SUMMARY

In general, in an aspect, a card blank has a first panel connected along a first fold line to a second panel. The second panel is connected along a second fold line to a third panel. The blank is foldable to form a first configuration in which the first panel, the second panel, and the third panel lie flat against one another. Alternately, the blank is foldable to form a second configuration in which (a) two of the panels can be mated to cause the folding card to form a three-dimensional free-standing card, (b) a bottom of the card has exposed points of contact that lie on a plane to permit the card to rest stably on a surface that is parallel to the plane, and (c) one of the panels is oriented at an angle of between 55 degrees and 85 degrees to the plane.

Implementations may include one or a combination of two or more of the following features. A piece of art is exposed for viewing on one of the panels when the blank is in the second configuration. Information is exposed for viewing on one of the panels when the blank is in the second configuration. The card blank includes a single integral sheet. The second panel is square, and the first panel and the third panel include respective features that enable them to be interlocked to mate them. Two of the panels are shorter than the third panel along a width of the card blank. Two of the panels are shorter than the third panel along a width of the card blank. The exposed points of contact include a straight bottom edge of one of the panels. The exposed points of contact include straight bottom edges of all three panels, the straight bottom edges of two of the panels each forming an angle of between 167 degrees and 173 degrees to the straight bottom edge of the third panel.

In general, in an aspect, a folding card includes a single integrated sheet having a first panel connected to a second panel along a first fold line and a third panel connected to the second panel along a second fold line. One of the panels has a front face that bears a work of art for display. The panels are configured to be folded along the two fold lines to lie flat against one another, and to be unfolded and mated to form a freestanding three-dimensional card that can rest on a surface with a front face of the first panel lying at an angle in a range of 55 degrees to 85 degrees to the surface on which the card rests.

Implementations may include one or a combination of two or more of the following features. The card includes a single die cut piece of card stock. The piece of art includes a photograph. The center panel is square. Two of the panels include flaps that include fingers that can be clasped to form the freestanding three-dimensional card.

In general, in an aspect, a card includes a single cut sheet of cardstock having a square center panel bearing a piece of art and two side flaps extending from the center panel at fold lines. The side flaps have slots that can be interlocked when the side flaps are folded behind the center panel to form a freestanding card that can rest on a surface with the piece of art at an angle of between 55 degrees and 85 degrees to the surface for viewing. The side flaps are foldable to lie flat against a back of the center panel for insertion into an envelope so that the envelope and card with the piece of art weighs no more than one ounce.

In general, in an aspect, a card package includes a clear sleeve and, inside the clear sleeve, a postage stamp, an envelope, and a card. The card includes a single cut sheet of cardstock having a center panel bearing a piece of art and two side flaps extending from the center panel at fold lines. The side flaps have features that can be interlocked when the side flaps are folded behind the center panel to form a card that is freestanding when resting on a surface, with the piece of art at an angle of between 55 degrees and 85 degrees to the surface. The side flaps are foldable to lie flat against the center panel for insertion into the envelope. The envelope and the card weigh no more than one ounce. And the piece of art, the envelope, and the stamp are visible through the sleeve.

In general, in an aspect, a card includes a card blank including a single integral sheet having a first panel connected along a first fold line to a square second panel. The square second panel is connected along a second fold line to a third panel. The first and third panels are each trapezoidal, and each has a broad end at the respective first fold line or the second fold line and a narrow free end. Each of the first and third panels has a length in the direction of a length of the card blank that is greater than the length of a side of the square second panel. Each of the first and third panels has a mating finger near its free end. The mating fingers are oriented in opposite directions relative to the length of the card blank. The three panels each have straight bottom edges that meet one another at the fold lines. The straight bottom edges of each of the first and third panel form angles of between 167 degrees and 173 degrees with the straight bottom edge of the square second panel, the blank being foldable to form a first configuration in which the first panel, the second panel, and the third panel lie flat against one another, and alternately to form a second configuration in which (a) the first and third panels can be mated to cause the folding card to form a three-dimensional free-standing card, (b) the straight edges of the three panels form a triangle that lies on a plane to permit the card to rest stably on a surface that is parallel to the plane, and (c) the second panel is oriented at an angle of between 55 degrees and 85 degrees to the plane, and a photograph or other piece of art work or a message exposed for viewing on one of the panels when the blank is in the second configuration.

These and other aspects, features, implementations, and advantages, and combinations of them, can be expressed as methods, apparatus, parts, systems, methods of doing business, means or steps for performing functions, and in other ways.

Other aspects, features, implementations, and advantages will become apparent from the following description and from the claims.

### DESCRIPTION

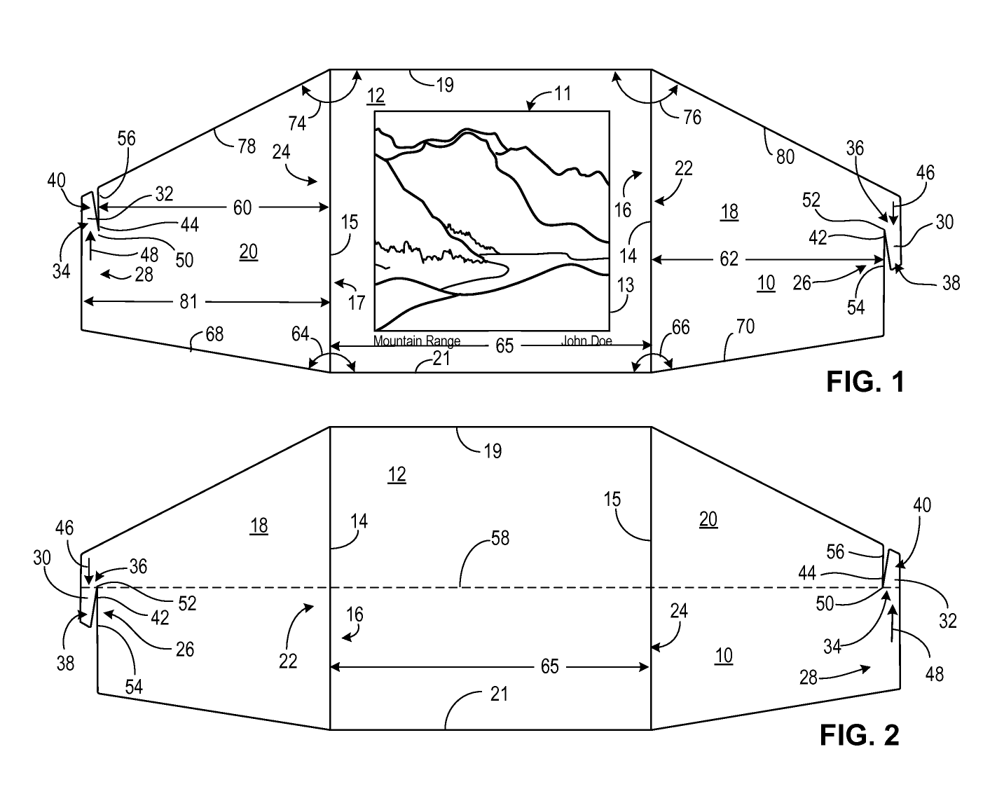

FIG. 1 is a top view of a card blank.

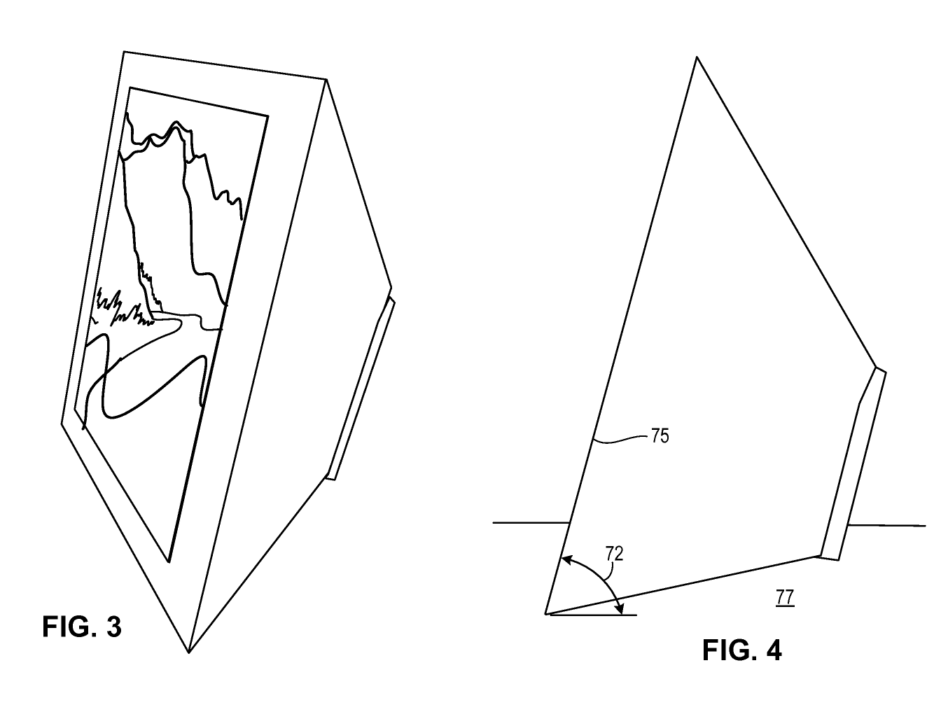

FIG. 2 is a bottom view of a card blank.

FIG. 3 is a perspective view of a card.

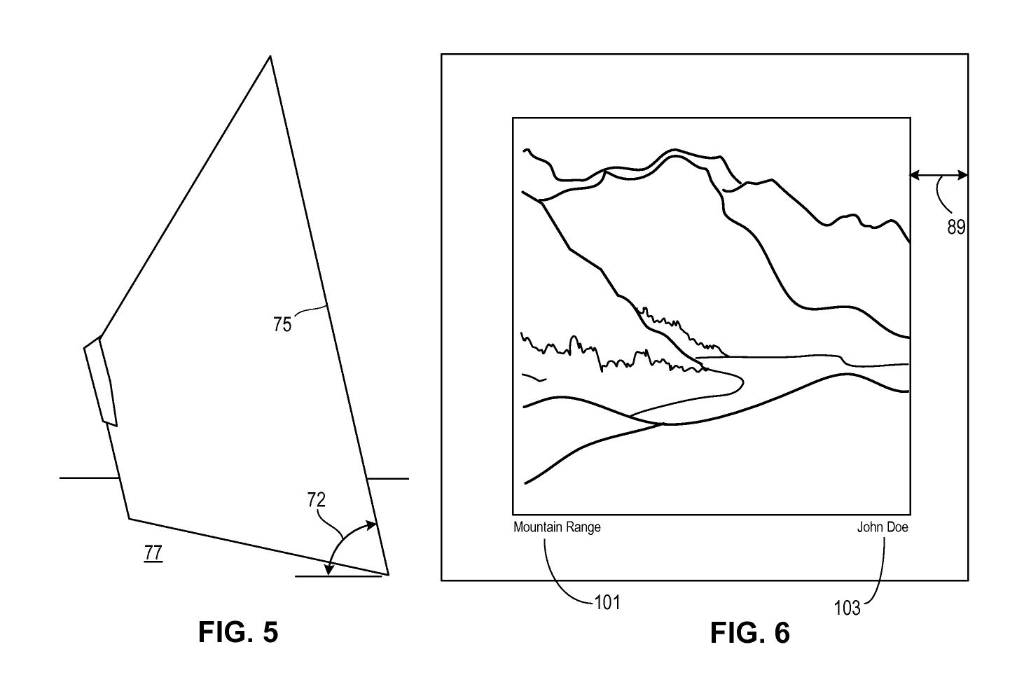

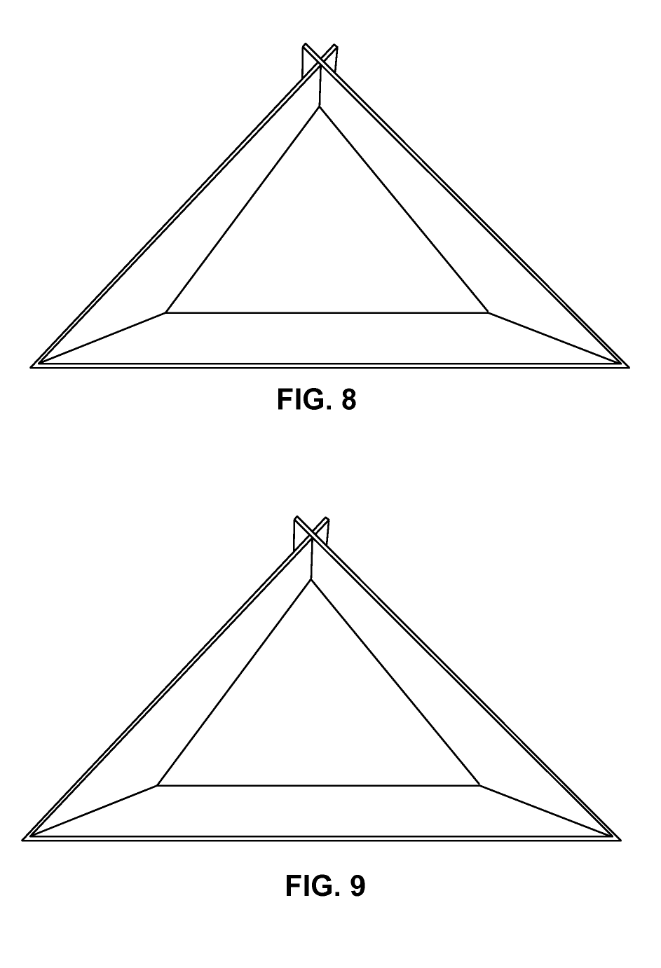

FIGS. 4, 5, 6, 7, 8, and 9 are right side, left side, front, rear, bottom, and top of a folded card.

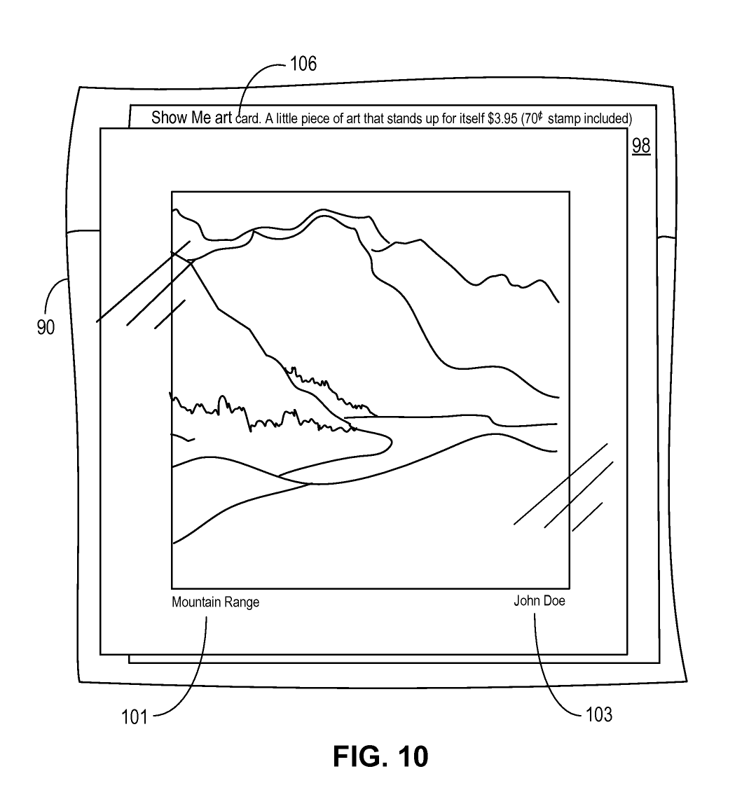

FIG. 10 is a front view of a card package.

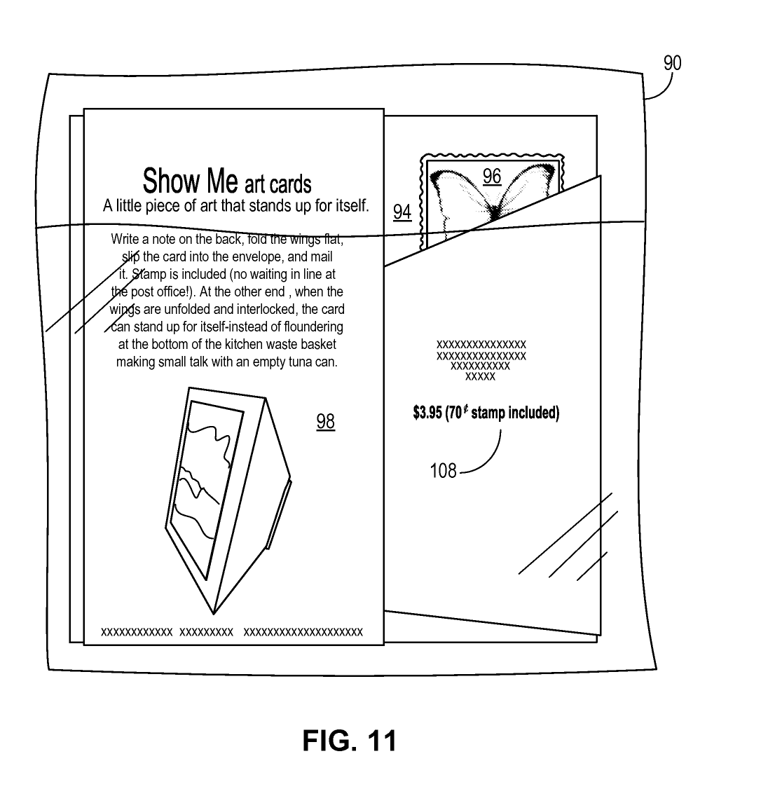

FIG. 11 is a rear view of a card package.

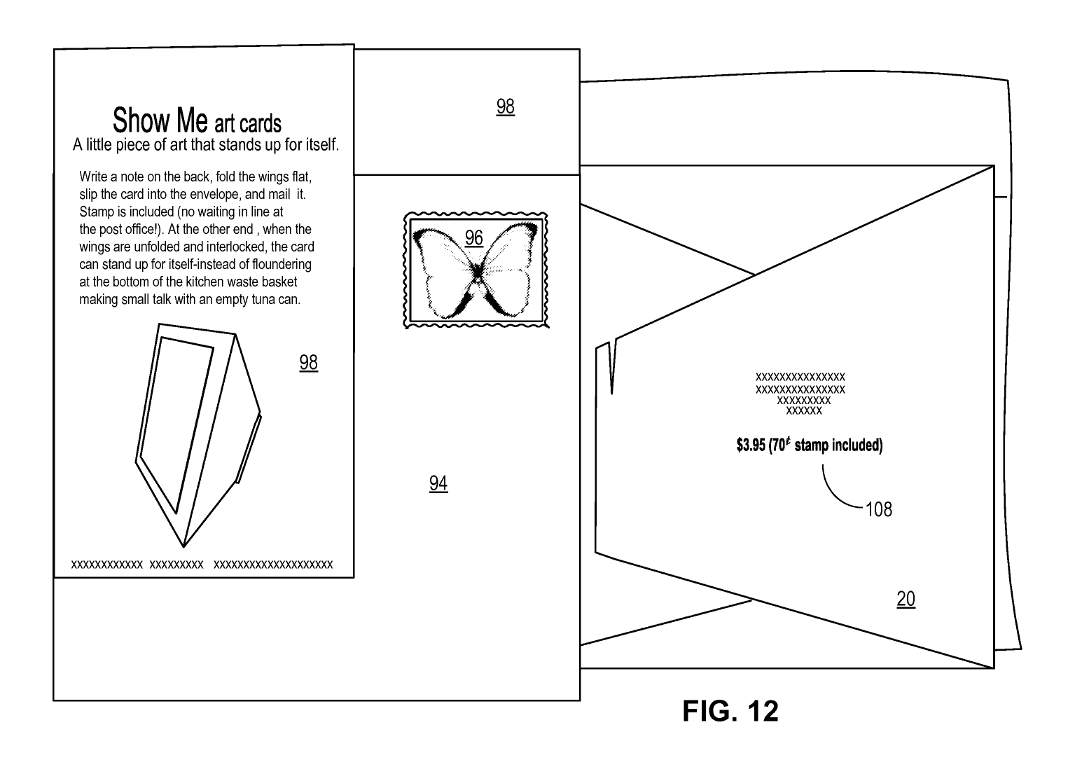

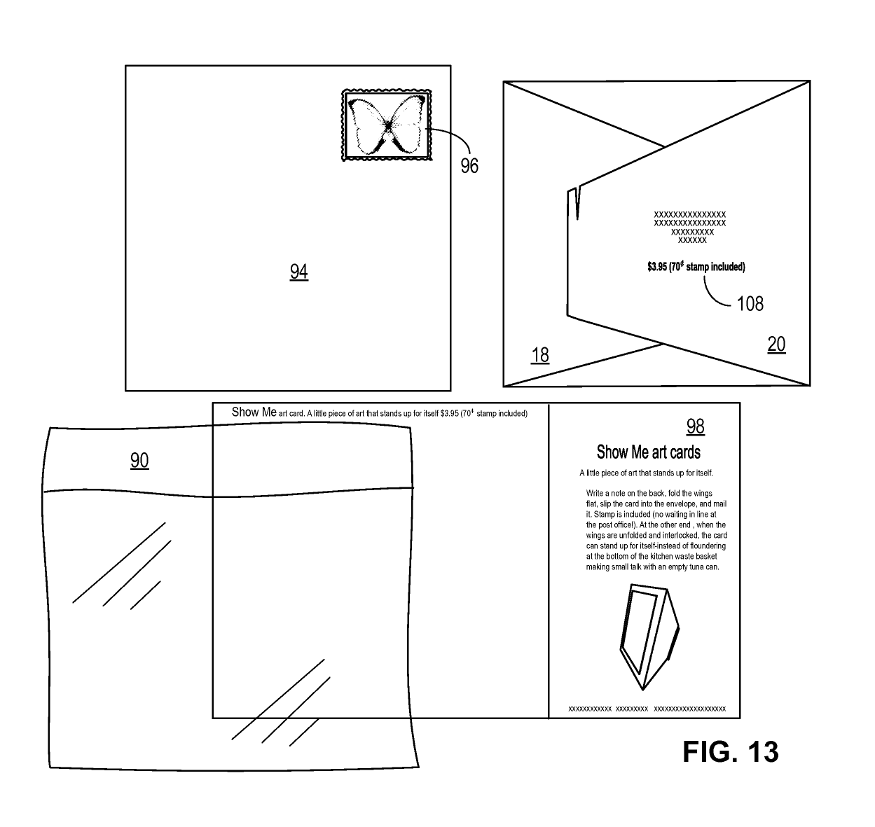

FIGS. 12 and 13 are views of parts of a card package.

As shown in FIGS. 1 and 2, in some examples, a die cut and scored blank 10 is to be used as a folding card for displaying art work such as a fine art photograph 13. In some implementations, the blank has a square main center panel 12 on which the photograph or other piece of art 13 is formed or printed or mounted using glue dots 11 or other adhesive.

The center panel is connected along two parallel scored lines 14, 15 located at two opposite edges 16, 17 of the center panel to two respective flaps 18, 20. Each scored line runs from one edge 19 to the opposite edge 21 of the blank. Each of the flaps has one end 22, 24 that is joined to the center panel along a corresponding one of the scored lines 14, 15 and has an opposite, free end 26, 28.

At the free end of each of the flaps is a finger 30, 32 that extends from a base end 34, 36 of the finger to a free end 38, 40 of the finger. Each of the fingers is separated from the corresponding flap by a long, narrow slot 42, 44. The fingers of the two flaps extend from their base ends in opposite directions 46, 48. Each of the slots is triangular, ending in a point 50, 52, and beginning at an opening 54, 56. The points of the two slots lie on an imaginary line 58 that extends across the sheet at a location that is halfway between the top edge 19 and the bottom edge 21 of the blank.

As shown in FIG. 13, in one aspect of use of the card blank, the two flaps 18, 20 can be folded in the same direction to lie generally behind the plane of the center panel (leaving the center panel and piece of art exposed to view). When the two flaps have been folded far enough behind the center panel, the two fingers 30, 32 can be clasped by interlocking them at their slots to form a freestanding (self-supporting) three-dimensional card 33 that can rest on a surface 35 with the piece of art exposed for viewing (see FIG. 3, for example).

In the implementations shown in FIGS. 1 and 2, the length 65 of the bottom edge of the center panel, the distances 60, 62 from the scored lines to the edges of the respective slots of the two flaps, and the angles 64, 66 that the straight bottom edges 68, 70, of the two flaps form with the bottom edge of the center panel are chosen so that when the card is resting on a surface, the angle 72 (FIG. 4) that the plane 75 of the center panel forms with the surface 77 allows for comfortable viewing of the piece of art by a viewer whose eyes are at a range of distances above the surface, for example, a viewer who is sitting or standing at a desk or table on which the card rests. The angles 64, 66 could be, for example, in the range of 165 degrees to 175 degrees, or in the range of 167 degrees to 173 degrees, or in some examples about 170 degrees.

Said in another way, the folded card with the clasped flaps forms a self-supporting three-dimensional object that provides places of contact with the surface that lie on a plane parallel to the plane of the surface on which the card rests and that parallel plane forms an angle 72 to the plane of the center panel that allows for comfortable viewing of the piece of art work. Angle 72 can be chosen to provide comfortable viewing based on the height of the viewer's eyes above the surface on which the card rests, the height of the surface on which the card rests, and the type of surface on which the card rests (for example, the top of a dresser). In some cases the angle can be between 85 degrees and 55 degrees or between 78 degrees and 72 degrees, or in some cases approximately 75 degrees.

The angles 74, 76 between the straight upper edges 78, 80, of the flaps and the top edge 19 of the card are small enough so that the free ends of the flaps are tall enough to accommodate the fingers, and the angles 74, 74 are large enough to make it easy to clasp the two fingers, to reduce excess area occupied by the flaps, and to be visually attractive. The angles 74, 74 could be in the range 144 degrees to 174 degrees or 150 degrees to 158 degrees or in some examples 154 degrees.

In some cases, the blank 10 is formed by die cutting and scoring a rectangular sheet of card stock or Bristol board or heavy paper. The sheet is rigid enough to enable the card to be freestanding when the fingers have been clasped, and the sheet can otherwise be as thin and lightweight as desired. In some cases, the weight of the card, artwork, and an envelope are chosen to reduce the postage cost of mailing the card in an envelope.

The color, texture, and surface of the stock from which the blank 10 is cut can be chosen to complement the piece of art attached to the sheet. In some cases, the stock is white or off-white and has a smooth surface. The stock can be oriented during cutting of the sheet so that the fiber of the stock permits the flaps to be folded neatly along the scored lines without forming a ragged or rough edge.

In some cases, each of the flaps is no longer than, and typically is modestly shorter 81 than the width 65 of the center panel. The flaps are typically long enough to assure the stability of the folded card with flaps clasped and short enough to reduce the total amount of material used and to reduce the area occupied on the surface on which the card rests.

In another stage of use, for insertion into an envelope for mailing, for example, the flaps can be folded flat against the front or the back of the center panel.

The card can be used as a note card or a greeting card or for a wide variety of other purposes such as marketing, table tents, promotional devices, signs, calendars, and place cards, to name a few. A message can be written on either or both sides of any of the panels and in particular on the back of the center panel. Art work can appear on either or both sides of any of the panels.

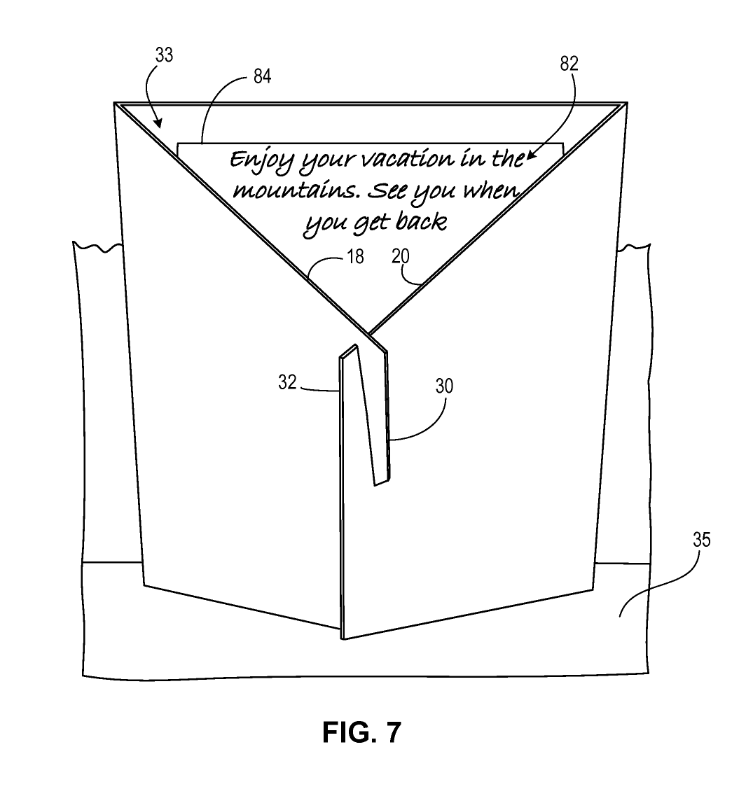

The blank can be printed to bear a message 82 (FIG. 7) of the kind used for greeting cards or appropriate for any other use of the care, or to bear a square outline 84 to define a target within which a message can be handwritten or printed. Decorations can be printed on either or both sides of the sheet.

The piece of art can be printed on the blank or attached to the blank or a combination of the two. The piece of art can be the same size and shape as the center panel or can be smaller than the center panel and surrounded by a border 89 (FIG. 6) or can be larger than the center panel and can be of a different shape. For example, the piece of art can extend above the top edge of the center panel by a small or large amount. A title of the work 101 and the artist's signature 103 can be printed or hand-written on the center panel, for example, beneath the bottom edge of the piece of art.

In particular examples used for greeting cards, the center panel is square, for example 4″, 4½″, 5″, 5½″, 6″, 6½″ or 7″ on a side. The photograph or other piece of art can be square and the same size as or smaller than the center panel by some amount such as ¼″, ½″, ¾″, or 1″, for example.

As shown in FIGS. 10, 11, 12, and 13, for display or marketing, the card can be part of a package that includes (a) an outer clear envelope 90 containing the card with flaps folded flat behind the center panel and the piece of art visible through the clear sleeve (FIG. 10), (b) a mailing envelope 94 slightly larger than the folded card, and in some cases (c) a postage stamp 96 in a denomination sufficient to mail the envelope with the folded card, for example postage that is appropriate for a one ounce first class letter plus a surcharge assessed for the squareness of the envelope.

In some implementations, the package also includes a page 98 that explains how to use the card and that faces in the opposite direction as the piece of art and is readable through the sleeve. The page 98 can be folded over the envelope and the envelope and page then together inserted behind one flap and in front of the other flap with the front of the envelope facing away from the front of the center panel. A small line of text 106 also printed on the page 98 can then appear above the piece of art when the package is viewed from the front.

The face of one of the flaps can also bear a sticker 108 that provides price, copyright, and other information. When the package is assembled, the viewer can see the piece of art and the small line of text by looking through the front of the clear envelope, and can see the envelope, the included postage, one flap of the blank, the copyright and price notice, and the page 98, all at once, by looking through the back of the clear envelope. In other words, the user can see all of the included items and can get a sense for how the card is constructed and works.

In some particular examples, the center panel is 5″ on a side, the flaps extend 4″ from the scored lines, the piece of art is a photograph that is about 4″ square, the angle of the plane of the center panel to a surface on which the card is resting is about 75 degrees, the sheet is die cut and scored from white, smooth-surfaced card stock, and the weight of the card and envelope together is less than one ounce.

In some cases, the piece of art is a work of an artist who lives in a location that is local to (e.g., no more than 5 miles from) the place where the card is sold or delivered, or a subject depicted in the piece of art is local to (e.g., no more than 5 miles from) the place where the card is sold or delivered to lend a local flavor to the marketed card.

A user of the card can write a message on the back of the center panel, fold the flaps flat behind the panel, insert the card into the envelope, and mail it. The recipient can then unfold the card, read the message, clasp the fingers, and set the folded card on a surface with the piece of art visible.

Among other advantages, the card is freestanding and will remain (without requiring any adhesive or other attachment device) in its free-standing three-dimensional configuration with the fingers clasped and can rest stably on a surface without collapsing, drooping or falling over. The angle between the center panel and the surface on which it rests makes the piece of art easy to see and enjoy. The card can be left resting on the surface and enjoyed for a long time without falling over or drooping or sagging. The recipient can enjoy the local association of the artist or the place depicted. Because of the shapes of the flaps, the message on the back is mostly hidden from view, for example, of people other than the recipient, but can be enjoyed by the recipient by unclasping the fingers. The fingers can be clasped and unclasped repeatedly so that the card can be folded flat and stored or unfolded and displayed repeatedly. The configuration of the slots of the fingers makes them easy to clasp and unclasp repeatedly without damaging the fingers or the card. The card is cheap and easy to make and distribute.

A wide variety of alternatives to the features of the card described above are also possible.

For example, the center panel can be rectangular or a variety of other shapes. The size of the center panel can be larger or smaller than the examples given earlier. The blank 10 can be a single integrated sheet or can be assembled from two or more pieces. The blank can be laser cut or scissors cut or formed in other ways. The sheet can be of plastic, metal, paper, cardboard, or any other material that has enough rigidity and other characteristics to serve the other functions discussed above. The flaps can have a variety of other shapes and sizes. The flaps can be arranged so that they do not span the full height of the center panel and can be located, for example, near the bottom of the center panel so that the flaps are a much less prominent aspect of the design of the card and the piece of art is given more prominence visually. The piece of art can appear on the flaps as well as or instead of on the center panel.

The panel on which the piece of art appears need not be the center panel. Rather the three panels could include a first panel, a second panel, and a third panel in that order, with the piece of art on the first panel. Then the two other panels can be folded with the third panel clasped to the first panel to form the three-dimensional card.

The two side panels could be connected to the top and bottom of the center panel rather than to its left and right sides. Then one of the panels can serve as a surface that lies on the surface on which the folded card rests.

Other implementations are also within the scope of the following claims.

1. An apparatus comprising
a card blank having a first panel connected along a first fold line to a second panel, the second panel connected along a second fold line to a third panel,
the blank being foldable to form a first configuration in which the first panel, the second panel, and the third panel lie flat against one another, and alternately to form a second configuration in which (a) two of the panels can be mated to cause the folding card to form a three-dimensional free-standing card, (b) a bottom of the card has exposed points of contact that lie on a plane to permit the card to rest stably on a surface that is parallel to the plane, and (c) one of the panels is oriented at an angle of between 55 degrees and 85 degrees to the plane.

2. The apparatus of claim 1 comprising a piece of art exposed for viewing on one of the panels when the blank is in the second configuration.

3. The apparatus of claim 1 comprising information exposed for viewing on one of the panels when the blank is in the second configuration.

4. The apparatus of claim 1 in which the card blank comprises a single integral sheet.

5. The apparatus of claim 1 in which the second panel is square, and the first panel and the third panel comprise respective features that enable them to be interlocked to mate them.

6. The apparatus of claim 1 in which two of the panels are shorter than the third panel along a width of the card blank.

7. The apparatus of claim 1 in which two of the panels are shorter than the third panel along a width of the card blank.

8. The apparatus of claim 1 in which the exposed points of contact comprise a straight bottom edge of one of the panels.

9. The apparatus of claim 1 in which the exposed points of contact comprise straight bottom edges of all three panels, the straight bottom edges of two of the panels each forming an angle of between 167 degrees and 173 degrees to the straight bottom edge of the third panel.

10. A folding card comprising
a single integrated sheet having a first panel connected to a second panel along a first fold line and a third panel connected to the second panel along a second fold line, one of the panels having a front face that bears a work of art for display,
the panels being configured to be folded along the two fold lines to lie flat against one another, and to be unfolded and mated to form a freestanding three-dimensional card that can rest on a surface with a front face of the first panel lying at an angle in a range of 55 degrees to 85 degrees to the surface on which the card rests.

11. The card of claim 1 comprising a single die cut piece of card stock.

12. The card of claim 1 in which the piece of art comprises a photograph.

13. The card of claim 1 in which the center panel is square.

14. The card of claim 1 in which two of the panels comprise flaps that include fingers that can be clasped to form the freestanding three-dimensional card.

15. A card comprising
a single cut sheet of cardstock having a square center panel bearing a piece of art and two side flaps extending from the center panel at fold lines, the side flaps having slots that can be interlocked when the side flaps are folded behind the center panel to form a freestanding card that can rest on a surface with the piece of art at an angle of between 55 degrees and 85 degrees to the surface for viewing, the side flaps being foldable to lie flat against a back of the center panel for insertion into an envelope so that the envelope and card with the piece of art weighs no more than one ounce.

16. A card package comprising
a clear sleeve,
inside the clear sleeve, a postage stamp, an envelope, and a card,
the card comprising
a single cut sheet of cardstock having a center panel bearing a piece of art and two side flaps extending from the center panel at fold lines, the side flaps having features that can be interlocked when the side flaps are folded behind the center panel to form a card that is freestanding when resting on a surface, with the piece of art at an angle of between x degrees and y degrees to the surface, the side flaps being foldable to lie flat against the center panel for insertion into the envelope,
the envelope and the card weighing no more than one ounce, and
the piece of art, the envelope, and the stamp being visible through the sleeve.

17. A card comprising
a card blank comprising a single integral sheet having a first panel connected along a first fold line to a square second panel, the square second panel connected along a second fold line to a third panel,
the first and third panels each being trapezoidal and each having a broad end at the respective first fold line or the second fold line and a narrow free end, each of the first and third panels having a length in the direction of a length of the card blank that is greater than the length of a side of the square second panel, each of the first and third panels having a mating finger near its free end, the mating fingers oriented in opposite directions relative to the length of the card blank,
the three panels each having straight bottom edges that meet one another at the fold lines, the straight bottom edges of each of the first and third panel forming angles of between 167 degrees and 173 degrees with the straight bottom edge of the square second panel,
the blank being foldable to form a first configuration in which the first panel, the second panel, and the third panel lie flat against one another, and alternately to form a second configuration in which (a) the first and third panels can be mated to cause the folding card to form a three-dimensional free-standing card, (b) the straight edges of the three panels form a triangle that lies on a plane to permit the card to rest stably on a surface that is parallel to the plane, and (c) the second panel is oriented at an angle of between 55 degrees and 85 degrees to the plane, and
a photograph or other piece of art work or a message exposed for viewing on one of the panels when the blank is in the second configuration.
